(19) United States
(12) Patent Application Publication
(10) Pub. No.: US 2021/0375516 A1
(43) Pub. Date: Dec. 2, 2021

(54) SUPERCONDUCTING TUNABLE INDUCTANCE

(71) Applicant: D-WAVE SYSTEMS INC., Bumaby (CA)

(72) Inventors: George E. G. Sterling, Vancouver (CA); Andrew J. Berkley, Vancouver (CA)

(21) Appl. No.: 17/327,230

(22) Filed: May 21, 2021

Related U.S. Application Data
(60) Provisional application No. 63/032,235, filed on May 29, 2020.

(51) Int. Cl. H01F 6/06; H01F 21/00; H01F 41/04

(52) U.S. Cl. CPC H01F 6/06; H01F 41/048; H01F 21/00

(57) ABSTRACT

A superconducting integrated circuit is fabricated by depositing a ground plane to at least partially overlie a substrate, depositing an insulating layer to at least partially overlie the ground plane, depositing a superconducting layer to at least partially overlie the insulating layer, and forming a superconducting feature in the superconducting layer. An inductance of the superconducting feature is tunable by adjusting a bias current in the ground plane. The ground plane is electrically communicatively coupleable to an electrical ground. Depositing a ground plane includes depositing a first superconducting material to at least partially overlie the substrate and depositing a second superconducting material to at least partially overlie the first superconducting material. A second critical current density of the second superconducting material is higher than a first critical current density of the first superconducting material.

### BACKGROUND

### Field

This disclosure generally relates to superconducting devices, and, in particular, to fabrication and operation of a superconducting tunable inductance.

### BRIEF SUMMARY

A method of fabricating a superconducting integrated circuit may be summarized as comprising depositing a ground plane to at least partially overlie a substrate, the ground plane which is electrically communicatively coupleable to an electrical ground, depositing an insulating layer to at least partially overlie the ground plane, depositing a superconducting layer to at least partially overlie the insulating layer, and forming a superconducting feature in the superconducting layer, wherein an inductance of the superconducting feature is tunable by adjusting a bias current in the ground plane, and wherein the depositing a ground plane includes depositing a first superconducting material to at least partially overlie the substrate and depositing a second superconducting material to at least partially overlie the first superconducting material, a second critical current density of the second superconducting material which is higher than a first critical current density of the first superconducting material.

In some implementations, the depositing a ground plane to at least partially overlie a substrate includes depositing the ground plane to at least partially overlie a silicon substrate.

In some implementations, the depositing an insulating layer to at least partially overlie the ground plane includes planarizing the insulating layer. In some implementations, the depositing an insulating layer to at least partially overlie the ground plane includes depositing a low-loss dielectric. In some implementations, the depositing a low-loss dielectric includes depositing silicon dioxide.

In some implementations, the depositing a superconducting layer to at least partially overlie the insulating layer includes depositing at least one of niobium or aluminum. In some implementations, the forming a superconducting feature in the superconducting layer includes patterning the superconducting layer by at least one masking and at least one etching.

In some implementations, the depositing a first superconducting material includes depositing at least one of titanium nitride or niobium nitride. In some implementations, the depositing a second superconducting material to at least partially overlie the first superconducting material includes depositing at least one of niobium or aluminum. In some implementations, depositing a second superconducting material to at least partially overlie the first superconducting material, a second critical current density of the second superconducting material which is higher than a first critical current density of the first superconducting material includes depositing the second superconducting material to at least partially overlie the first superconducting material, the second critical current density of the second superconducting material which is greater than 2×10⁻³ amperes.

A tunable inductance may be summarized as comprising a substrate, a ground plane at least partially overlying the substrate, the ground plane comprising a first layer of a first superconducting material at least partially overlying the substrate and a second layer of a second superconducting material, the second layer at least partially overlying the first layer, the ground plane which is electrically communicatively coupleable to an electrical ground, an insulating layer at least partially overlying the ground plane, a superconducting layer at least partially overlying the insulating layer, and a superconducting inductance formed in the superconducting layer; wherein a second critical current density of the second superconducting material is higher than a first critical current density of the first superconducting material.

In some implementations, the substrate includes a silicon substrate. In some implementations, the insulating layer includes a planarized insulating layer. In some implementations, the insulating layer includes a low-loss dielectric. In some implementations, the low-loss dielectric includes silicon dioxide.

In some implementations, the superconducting layer includes at least one of niobium or aluminum. In some implementations, the superconducting inductance includes a pattern, the pattern which includes at least one feature selected from the group consisting of a straight line, a spiral, and a meander.

In some implementations, the first superconducting material includes at least one of titanium nitride or niobium nitride. In some implementations, the second superconducting material includes at least one of niobium or aluminum. In some implementations, the second critical current density of the second superconducting material is greater than 2×10⁻³ amperes.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a flow chart of a method of fabrication of a superconducting integrated circuit, according to the systems and methods of the present disclosure.

FIGS. 2A to 2F are sectional views of a portion of an exemplary superconducting integrated circuit which includes a superconducting tunable inductor, at various stages of its fabrication, according to the systems and methods of the present disclosure.

FIG. 3 is a schematic diagram illustrating an example implementation of a superconducting tunable inductance, according to the systems and methods of the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with quantum processors, qubits, couplers, controller, readout devices and/or interfaces have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one example”, “an example”, “one embodiment” or “an embodiment” means that a particular feature, structure or characteristic described in connection with the embodiment is included in at least one embodiment. Thus, the appearances of the phrases “in one example”, “in an example”, “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims, the terms “overlap,” “overlapping” and the like, mean a projection of a boundary of the recited structure with respect to the boundary of another structure, and includes overlying with and without intervening items between the recited structures. For example, one loop may overlap a loop on the next wiring layer below, or two wiring layers below, and the like. The terms “overlap,” “overlapping” and the like apply without respect to orientation, that is without respect to whether one structure resides above or below another structure.

The headings and Abstract of the Disclosure provided herein are for convenience only and do not interpret the scope or meaning of the embodiments.

### Tunable Inductance

Inductance is the tendency of an electrical conductor to oppose a change in the electric current flowing through it. A component that adds inductance to a circuit is referred to in the present application as an inductor. An ideal inductor has no resistance and therefore no power dissipation. An inductor may include a length, a coil, a spiral, or a helix of wire. Current flowing through an inductor can generate a magnetic field in which energy can be stored. The magnetic energy stored in an inductor can be proportional to the square of the current flowing through the inductor.

Magnetic self-inductance can be described by Faraday's law, and can depend on an energy stored in a magnetic field caused by a current. It can be challenging to make a large magnetic inductance in a compact planar geometry, for example in an integrated circuit.

Kinetic inductance is a consequence of kinetic energy stored in the motion of charge carriers of an electrical conductor. In a superconductor, where electrical DC resistance is zero, an impedance (from DC to GHz frequencies) can be dominated by a kinetic inductance of a supercurrent. A supercurrent is an electrical current flowing in a superconductor.

It can be desirable to be able to tune an inductor over a wide range of values (for example, over values that differ by at least one order of magnitude) while carrying an appreciable supercurrent (for example, a supercurrent of ˜5 mA).

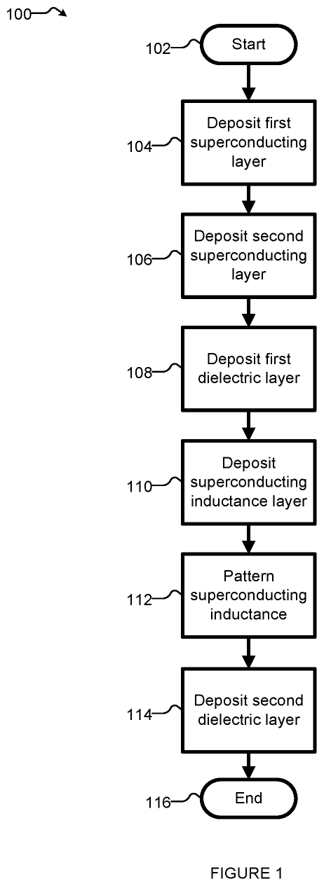

FIG. 1 is a flow chart of an exemplary method 100 of fabrication of a superconducting integrated circuit, according to the systems and methods of the present disclosure. Method 100 includes acts 102-116, though those of skill in the art will appreciate that in other implementations certain acts may be omitted and/or additional acts may be added. Those of skill in the art will appreciate that the illustrated order of the acts in FIG. 1 is shown for exemplary purposes only and may change in other implementations.

Method 100 starts at 102, for example in response to an initiation of the fabrication process. At 104, method 100 deposits a first superconducting layer to overlie a substrate. In some implementations, the substrate is a silicon substrate. In some implementations, the first superconducting layer is deposited directly on the substrate. In some implementations, the first superconducting layer is a lower layer of a multi-layer ground plane. In some implementations, the multi-layer ground plane is a bi-layer. In some implementations, the first superconducting layer includes or consists of a material having a low carrier concentration and/or a high penetration depth. In some implementations, the first superconducting layer includes or consists of titanium nitride and/or niobium nitride.

At 106, method 100 deposits a second superconducting layer to overlie the first superconducting layer. In some implementations, the second superconducting layer is deposited directly on the first superconducting layer. In some implementations, the second superconducting layer is an upper layer of a multi-layer ground plane. In some implementations, the multi-layer ground plane is a bi-layer.

In the present application, the term lower layer refers to a layer in a set of layers (e.g., the layers of a multi-layer ground plane) that is closer to the substrate than the upper layer. The upper layer overlies the lower layer and the substrate, and the lower layer overlies the substrate, with or without intervening layers. Throughout this specification and the appended claims, the term “overlies” when used to describe two layers—for example, a first layer overlies a second layer)—is used to indicate that the first layer lies on top of the second layer with or without intervening layers.

In some implementations, the ground plane is a bi-layer and the first superconducting layer (i.e., the lower superconducting layer of the ground plane) is thicker than the second superconducting layer.

In some implementations, the second superconducting layer includes or consists of a material having a high carrier concentration and/or a low penetration depth. In some implementations, the second superconducting layer includes or consists of aluminum and/or niobium.

In some implementations, the second superconducting layer includes or consists of a material having a higher carrier concentration and/or a lower penetration depth than the first superconducting layer.

At 108, method 100 deposits a first dielectric layer to overlie the first and the second superconducting layer. In some implementations, the first dielectric layer is deposited directly on the second superconducting layer. In some implementations, the first dielectric layer includes or consists of silicon dioxide. In some implementations, depositing the first dielectric layer includes planarizing the first dielectric layer, for example by chemical mechanical planarization (CMP). In some implementations, the first dielectric layer forms a thin insulating layer. For example, the first dielectric layer may be thinner than the ground plane bi-layer.

At 110, method 100 deposits a superconducting inductance layer to overlie the first dielectric layer. In some implementations, the superconducting inductance layer is deposited directly on the first dielectric layer. In some implementations, the superconducting inductance layer includes or consists of a material having a high carrier concentration and/or a low penetration depth. In some implementations, the superconducting inductance layer includes or consists of the same material as the second superconducting layer. In some implementations, the superconducting inductance layer includes or consists of aluminum and/or niobium.

At 112, method 100 patterns the superconducting inductance layer to form a superconducting feature or a superconducting device, for example a superconducting inductance or a superconducting microstrip. A microstrip is a type of electrical transmission line which can be fabricated using printed circuit board technology, and can be used to convey microwave-frequency signals. A microstrip typically includes a conducting strip separated from a ground plane by a dielectric layer. A superconducting microstrip includes a superconducting strip separated from a ground plane by a dielectric layer. In some implementations, the superconducting inductance layer is patterned by masking and etching the superconducting inductance layer.

At 114, method 100 deposits a second dielectric layer to overlie the superconducting inductance layer. In some implementations, the second dielectric layer is deposited directly on the superconducting inductance layer. In some implementations, the second dielectric layer is deposited directly on an exposed portion of the first dielectric layer. In some implementations, the second dielectric layer includes or consists of silicon dioxide. In some implementations, depositing the second dielectric layer includes planarizing the second dielectric layer, for example by chemical mechanical planarization (CMP).

In some implementations, act 114 is omitted from method 100.

At 116, method 100 ends.

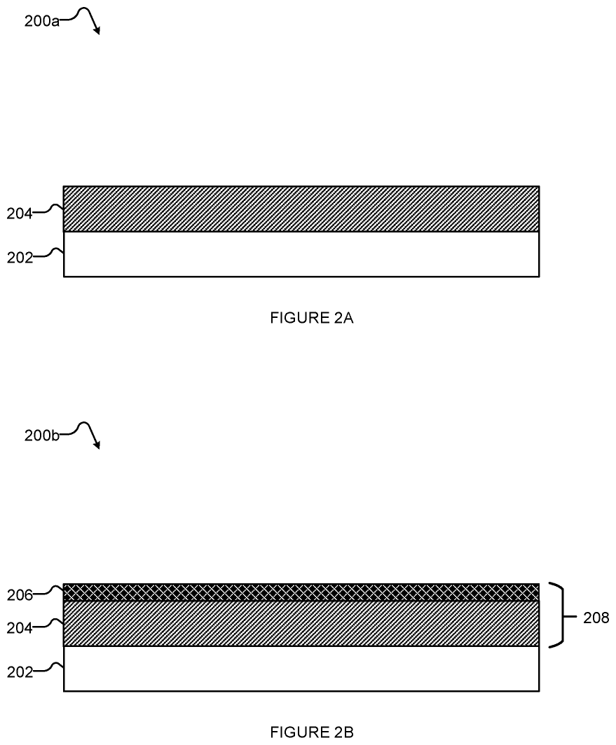

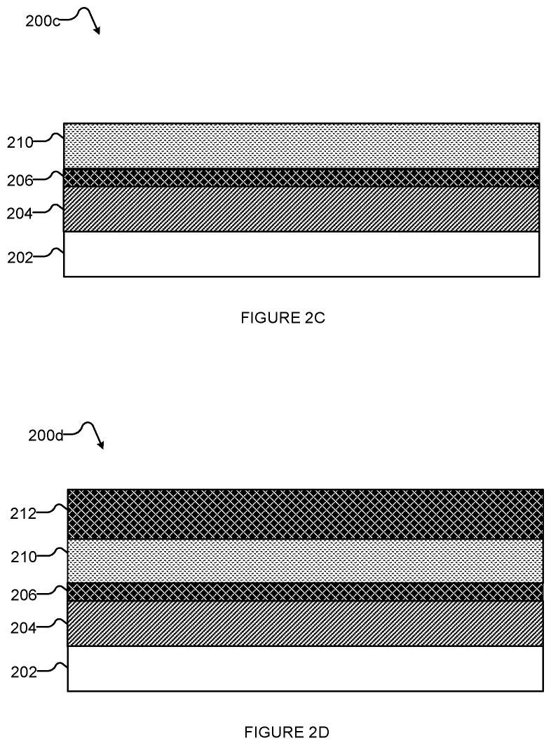

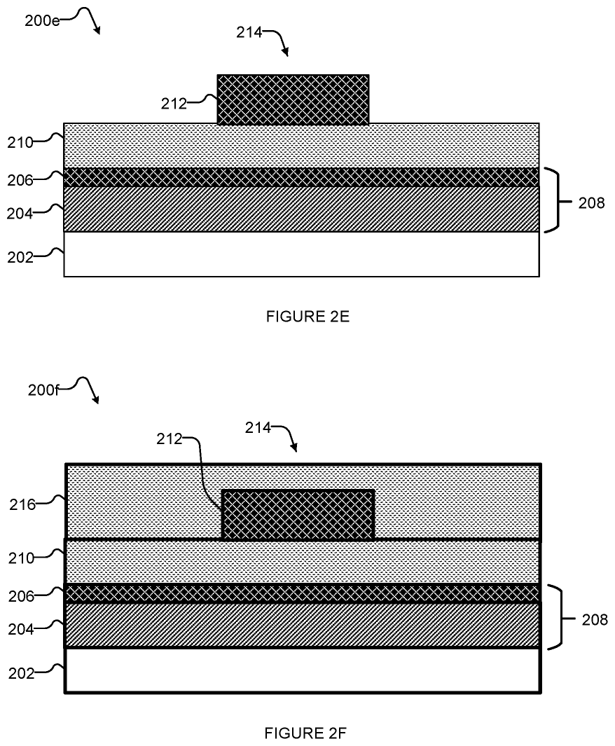

FIGS. 2A to 2F are sectional views of a portion of an exemplary superconducting integrated circuit which includes a superconducting tunable inductor, at various stages of its fabrication, according to the systems and methods of the present disclosure.

FIG. 2A is a sectional view of a portion of a superconducting integrated circuit 200a at a first stage of a fabrication process described by method 100 of FIG. 1. Circuit 200a comprises a substrate 202 and a superconducting layer 204. Superconducting layer 204 overlies substrate 202.

In some implementations, substrate 202 is a silicon substrate. In some implementations, superconducting layer 204 includes a superconducting material having a low carrier concentration and/or a high penetration depth. In some implementations, superconducting layer 204 includes one of titanium nitride or niobium nitride. In some implementations, superconducting layer 204 is a constituent layer of a superconducting bi-layer. In some implementations, the superconducting bi-layer is a ground plane of superconducting integrated circuit 200a.

FIG. 2B is a sectional view of a portion of a superconducting integrated circuit 200b at a subsequent stage of the fabrication process. Superconducting integrated circuit 200b can be formed from circuit 200a of FIG. 2A by depositing a superconducting layer 206 to overlie superconducting layer 204.

In some implementations, superconducting layer 206 includes one of niobium or aluminum. In some implementations, superconducting layer 206 is a constituent layer of a superconducting bi-layer 208. In some implementations, the superconducting bi-layer includes superconducting layers 204 and 206. In some implementations, superconducting bi-layer 208 is a ground plane of superconducting integrated circuit 200b, the ground plane which is electrically communicatively coupleable to an electrical ground.

FIG. 2C is a sectional view of a portion of a superconducting circuit 200c at a subsequent stage of the fabrication process. Superconducting integrated circuit 200c can be formed from circuit 200b of FIG. 2B by depositing a dielectric layer 210 to overlie superconducting layer 206. In some implementations, dielectric layer 210 is planarized or polished, for example by chemical mechanical planarization (CMP). In some implementations, dielectric layer 210 includes a low-loss dielectric. In some implementations, dielectric layer 210 includes silicon dioxide.

FIG. 2D is a sectional view of a portion of a superconducting circuit 200d at a subsequent stage of the fabrication process. Superconducting integrated circuit 200d can be formed from circuit 200c of FIG. 2C by depositing a superconducting layer 212 to overlie dielectric layer 210. In some implementations, superconducting layer 212 includes a superconducting metal, for example niobium or aluminum.

FIG. 2E is a sectional view of a portion of a superconducting circuit 200e at a subsequent stage of the fabrication process. Superconducting integrated circuit 200e can be formed from circuit 200d of FIG. 2D by patterning superconducting layer 212 to form a superconducting feature 214. In some implementations, superconducting feature 214 is a superconducting metal trace. In some implementations, superconducting feature 214 is an inductor. In some implementations, superconducting feature 214 is an element of a microstrip.

FIG. 2F is a sectional view of a portion of a superconducting circuit 200f at a subsequent stage of the fabrication process. Superconducting integrated circuit 200f can be formed from circuit 200e of FIG. 2E by depositing a dielectric layer 216 to overlie superconducting feature 214. In some implementations, dielectric layer 216 is planarized or polished, for example by chemical mechanical planarization (CMP). In some implementations, dielectric layer 216 includes silicon dioxide.

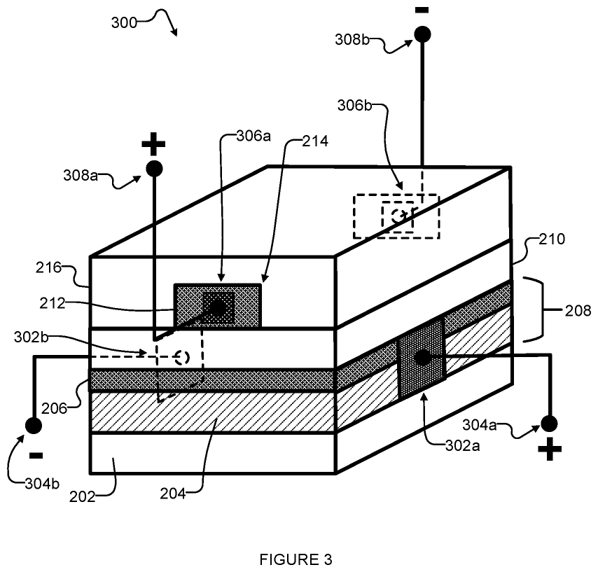

FIG. 3 is a schematic diagram illustrating an example implementation of a superconducting tunable inductance 300, according to the systems and methods of the present disclosure. Like numerals are used in FIG. 3 to indicate the same or similar elements shown in FIG. 2. For example, a substrate 202 of FIG. 3 is the same or similar element as substrate 202 of FIG. 2.

Tunable inductance 300 comprises substrate 202, and two superconducting layers 204 and 206 which form a bi-layer ground plane 208. An insulating layer 210 of dielectric overlies bi-layer ground plane 208. Superconducting inductance 214, formed by patterning superconducting inductance layer 212, overlies insulating layer 210, and is overlain by a dielectric layer 216. In some implementations, dielectric layer 216 is omitted.

Tunable inductance 300 includes contacts 302a and 302b (contact 302b shown using a dashed line in the view of tunable inductance 300 shown in FIG. 3) to bi-layer ground plane 208 for a DC current bias supplied via terminals 304a and 304b. Tunable inductance 300 also includes contacts 306a and 306b (contact 306b shown using a dashed line in the view of tunable inductance 300 shown in FIG. 3) to superconducting inductance 214 for a DC current bias supplied via terminals 308a and 308b.

In some implementations, tunable inductance 300 is a superconducting microstrip.

Bi-layer ground plane 208 can have a tunable penetration depth. A current approaching a critical current of bi-layer ground plane 208 driven through a current bias of bi-layer ground plane 208 (for example, a DC current bias supplied via terminals 304a and 304b) can cause a carrier concentration of the high carrier concentration material in bi-layer ground plane 208 to fall. More current can be shunted away through the low carrier concentration material of bi-layer ground plane 208. A resulting reduction of carriers in the upper (high carrier concentration material) layer of bi-layer ground plane 208 can cause the penetration depth of bi-layer ground plane 208 to increase, which allows more magnetic flux to penetrate bi-layer ground plane 208 from the current-carrying line above the ground plane i.e., superconducting inductance 214.

Tunable inductance 300 can be tuned by adjusting a bias current in bi-layer ground plane 208. For a given current in superconducting inductance 214 of superconducting tunable inductance 300, more magnetic energy can be stored when bi-layer ground plane 208 is current-biased (as described above), and so an inductance of tunable inductance 300 can be increased when bi-layer ground plane 208 is biased near the critical current.

The low carrier concentration material of lower layer 204 of bi-layer ground plane 208 can help to provide a smoother modulation of the effective penetration depth of bi-layer ground plane 208. In its absence, bi-layer ground plane 208 would likely transition to a normal-metal state as a bias current approaches the critical current (for example as a result of instability, thermal noise, and/or electronic noise). More noticeable changes to the penetration depth can occur as the bias current approaches the critical current.

In some implementations, a ten-fold increase in penetration depth occurs at a bias current of 95% of the critical current. In some implementations, a fifty-fold increase in penetration depth occurs at a bias current of 99% of the critical current. In practice, provided electronic noise fluctuations are sufficiently low, it can be possible to control a bias current close to 99% of the critical current. In some implementations, a shunting path in parallel with the ground plane is included to increase tolerance to noise current on a drive line. When the ground plane is biased at or near 99% of the critical current, noise added to a DC current signal with fluctuations on the order of 1% can cause problems in operation. Providing a parallel current path can increase an effective resolution of an upstream device controlling the current, and can divide the noise contribution, allowing some of the noise current to be redirected through the parallel path.

In some implementations (not shown in the example implementation of FIG. 3), a greater range in the tunability of the inductance can be achieved by arranging multiple microstrips such that adjacent wires (e.g., superconducting inductance 214) can interact to provide an N² increase in inductance, where N is the number of adjacent microstrips. In one implementation, the microstrips are arranged to form a planar spiral.

In the example implementation of FIG. 3, an input signal current in superconducting inductance 214 is driven from front to back of the isometric view i.e., from terminal 308a to terminal 308b. The current bias in bi-layer ground plane 208 can be driven either in the same (or the opposite) direction as the input signal current (i.e., parallel or anti-parallel to the current in the microstrip), or from one side of the isometric view to the other—either as shown in FIG. 3 from terminal 304a to terminal 304b, or from terminal 304b to terminal 304a.

In one example implementation, the critical current is 2×10⁻³ amperes, the baseline inductance is 200×10⁻⁹ henrys, and the tunable range is about 20%.

In some implementations, superconducting inductance 214 comprises a pattern formed in superconducting inductance layer 212. In some implementations, the pattern includes or consists of a straight line. In some implementations, the pattern includes or consists of a spiral. In some implementations, the pattern includes or consists of a meander.

In some implementations, bi-layer ground plane 208 includes a meander. The meander in bi-layer ground plane 208 can reduce the current needed to bias bi-layer ground plane 208 near the critical current.

A superconducting tunable inductance may be incorporated into a quantum processor or a switching device, for example. Other uses may include flux biasing devices, tunable resonators and filters, and digital-to-analog converters.

Throughout this specification and the appended claims, the term “superconducting” when used to describe a physical structure (for example, a “superconducting feature” or a “superconducting device”) is used to indicate a material that is capable of behaving as a superconductor at an appropriate temperature, for example at or below a critical temperature. A superconducting material may not necessarily be acting as a superconductor at all times in all implementations of the present systems and methods.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other analog processors, not necessarily the exemplary quantum processors generally described above.

The various embodiments described above can be combined to provide further embodiments. All of the commonly assigned US patent application publications, US patent applications, foreign patents, and foreign patent applications referred to in this specification and/or listed in the Application Data Sheet, including U.S. patent application 63/032,235 filed May 29, 2020, are incorporated herein by reference, in their entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of fabricating a superconducting integrated circuit, the method comprising:
depositing a ground plane to at least partially overlie a substrate, the ground plane which is electrically communicatively coupleable to an electrical ground;
depositing an insulating layer to at least partially overlie the ground plane;
depositing a superconducting layer to at least partially overlie the insulating layer;
forming a superconducting feature in the superconducting layer, wherein an inductance of the superconducting feature is tunable by adjusting a bias current in the ground plane, and wherein the depositing a ground plane includes depositing a first superconducting material to at least partially overlie the substrate and depositing a second superconducting material to at least partially overlie the first superconducting material, a second critical current density of the second superconducting material which is higher than a first critical current density of the first superconducting material.

2. The method of claim 1 wherein the depositing a ground plane to at least partially overlie a substrate includes depositing the ground plane to at least partially overlie a silicon substrate.

3. The method of claim 1 wherein the depositing an insulating layer to at least partially overlie the ground plane includes planarizing the insulating layer.

4. The method of claim 1 wherein the depositing an insulating layer to at least partially overlie the ground plane includes depositing a low-loss dielectric.

5. The method of claim 4 wherein the depositing a low-loss dielectric includes depositing silicon dioxide.

6. The method of claim 1 wherein the depositing a superconducting layer to at least partially overlie the insulating layer includes depositing at least one of niobium or aluminum.

7. The method of claim 1 wherein the forming a superconducting feature in the superconducting layer includes patterning the superconducting layer by at least one masking and at least one etching.

8. The method of claim 1 wherein the depositing a first superconducting material includes depositing at least one of titanium nitride or niobium nitride.

9. The method of claim 1 wherein the depositing a second superconducting material to at least partially overlie the first superconducting material includes depositing at least one of niobium or aluminum.

10. The method of claim 1 wherein the depositing a second superconducting material to at least partially overlie the first superconducting material, a second critical current density of the second superconducting material which is higher than a first critical current density of the first superconducting material includes depositing the second superconducting material to at least partially overlie the first superconducting material, the second critical current density of the second superconducting material which is greater than 2×10⁻³ amperes.

11. A tunable inductance comprising:
a substrate:
a ground plane at least partially overlying the substrate, the ground plane comprising a first layer of a first superconducting material at least partially overlying the substrate and a second layer of a second superconducting material, the second layer at least partially overlying the first layer, the ground plane which is electrically communicatively coupleable to an electrical ground;
an insulating layer at least partially overlying the ground plane;
a superconducting layer at least partially overlying the insulating layer; and
a superconducting inductance formed in the superconducting layer;
wherein a second critical current density of the second superconducting material is higher than a first critical current density of the first superconducting material.

12. The tunable inductance of claim 11 wherein the substrate includes a silicon substrate.

13. The tunable inductance of claim 11 wherein the insulating layer includes a planarized insulating layer.

14. The tunable inductance of claim 11 wherein the insulating layer includes a low-loss dielectric.

15. The tunable inductance of claim 14 wherein the low-loss dielectric includes silicon dioxide.

16. The tunable inductance of claim 11 wherein the superconducting layer includes at least one of niobium or aluminum.

17. The tunable inductance of claim 11 wherein the superconducting inductance includes a pattern, the pattern which includes at least one feature selected from the group consisting of a straight line, a spiral, and a meander.

18. The tunable inductance of claim 11 wherein the first superconducting material includes at least one of titanium nitride or niobium nitride.

19. The tunable inductance of claim 11 wherein the second superconducting material includes at least one of niobium or aluminum.

20. The tunable inductance of claim 11 wherein the second critical current density of the second superconducting material is greater than 2×10⁻³ amperes.
